(19) United States
(12) Patent Application Publication
(10) Pub. No.: US 2005/0020394 A1
(43) Pub. Date: Jan. 27, 2005

(54) Chain link for a bicycle and related chain

(75) Inventor: Maurizio Valle, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.I., Vicenza (IT)

(21) Appl. No.: 10/866,322

(22) Filed: Jun. 10, 2004

(30) Foreign Application Priority Data
Jun. 12, 2003 (EP) EP 03425383.1

(51) Int. Cl. F16H 7/06

(52) U.S. Cl. 474/155

(57) ABSTRACT

A chain link for a bicycle chain is disclosed that comprises a first coupling hole formed at a first end of the chain link; and a second coupling hole formed at a second end of the chain link opposite the first end. The coupling holes are adapted for receiving pins that couple a chain link with an adjoining chain link and the chain link defines at least one area of reduced thickness located between the first coupling hole and the second coupling hole.

### BACKGROUND

A transmission chain transfers power from a drive to a driven gear. A bicycle chain transmits power from the toothed crowns (i.e. the front sprockets) driven by the rider through the pedals to the sprockets of the rear wheel of the bicycle. Such a bicycle chain is commonly formed through a series of pairs of inner links and a series of pairs of outer links connected together in an articulated manner through pins. Rollers mounted about the pins engage inside valleys in the toothed crowns and sprockets. The chain's moving parts work together to transfer the driving power from a rider to the bicycle.

U.S. Pat. No. 5,322,483 to Wang discloses a chain having circular openings at the center of the links. The openings help with the lubrication of the chain and are obtained by drawing. That is, the openings are formed by bending the central portion of the chain link inwards without removing material. Therefore, the weight of the chain is not reduced with respect to chains without openings. Moreover, the central circular openings weaken the chain links.

Several considerations are important in chain design. Keeping these parts operational in different outdoor conditions is critical. Equally critical is that the chain links must be particularly strong. The chain, at the same time, must move easily between adjacent crowns and sprockets to allow the various gearshift ratios to be accomplished quickly and reliably.

To accomplish all of these goals, the chain link must be strong and at the same time, have a “slender” shape to ensure ease and reliability of gear-shifting. In the racing bicycle field, the goal of minimizing weight is often at odds with this strength requirement. Minimizing weight is difficult to achieve because most chains are made of a steel alloy. Lighter alloys, are not commonly used in chains. Therefore, the most common solutions for reducing the weight of the chain involve modifying existing steel alloy chains.

### SUMMARY

The object of the present invention is to create chain links that reduce chain weight while retaining its strength.

A transmission chain link with first and second ends and a central portion comprises a first and second coupling holes. The first coupling hole receives a pin and is formed near the first end of the chain link and the second coupling hole receives a pin and is formed near the second end of the chain link opposite the first end. The central portion has at least one area of reduced thickness with respect to the remaining part of the central portion.

### BRIEF DESCRIPTION OF THE DRAWING(S)

Further characteristics and advantages of the invention shall become clearer from the description of preferred embodiments, made with reference to the attached drawings.

FIG. 1 shows a plan view of an outer chain link.

FIG. 2 shows a plan view of an inner chain link.

FIG. 3 shows an exploded isometric view of a length of chain.

FIG. 4 shows an alternate embodiment of the chain link.

FIGS. 5 and 6 show non-limiting dimensions for the link shown in FIG. 2.

FIG. 7 is a cross-section of the outer link shown in FIG. 1 through the line VII-VII.

FIG. 8 is a plan view of an alternate embodiment of an outer chain link.

FIG. 9 is a cross-section of the link shown in FIG. 8 through the line IX-IX.

### DETAILED DESCRIPTION OF THE PREFERRED EMBODIMENT(S)

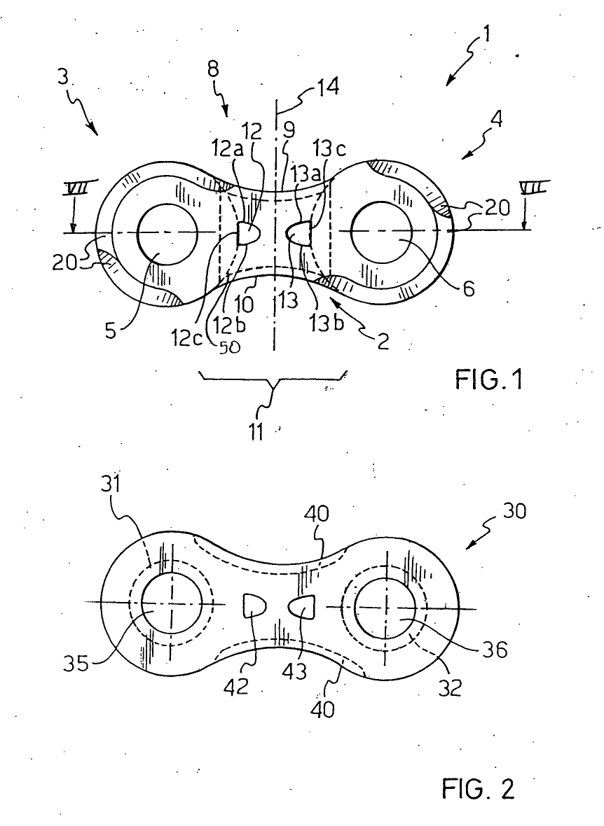

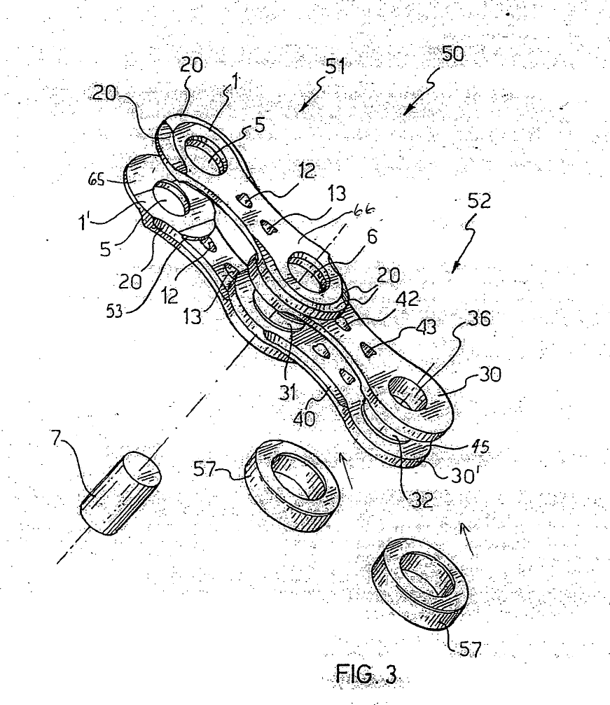

In FIG. 1, an outer chain link 1 comprises an elongated flat body 2, the ends 3, 4 of which are substantially circular and have a first coupling hole 5 and a second coupling hole 6, also circular. The coupling holes 5 and 6 allow for the insertion of pins 7, as can be seen in FIG. 3. The pins couple the outer link 1 with another outer link 1′ and with two inner links 30 and 30′ during assembly of a chain 50.

The rounded ends 3 and 4 are joined together by a central portion 8. The central portion 8 includes arced profiles 9, 10 that are part of a circumference of a predetermined radius chosen so as to provide the central part 8 and the entire link 1 with the adequate strength for use as a bicycle chain.

The link 1 has, in the region 11 between the two coupling holes 5 and 6, two through-holes or through-openings 12 and 13. These through-openings 12, 13 are preferably formed by removal of material, i.e. by removing the portion of the link using a process that forms through-openings 12 and 13 that reduce the weight of the link. Such removal can be carried out through punching, chip machining, laser cutting, or other effective means.

The through-openings 12, 13 are respectively made in region 11 between the center of the link 14 and one of the coupling holes 5 or 6. Specifically, the through-openings 12 and 13 are positioned between the center of the link 1 and the rounded end portions 3 and 4. The size of the through-openings 12 and 13 increases going from the center 14 of the link towards the respective coupling hole 5 or 6. The profiles 12a, 13a and 12b, 13b of the openings 12 and 13 are essentially parallel with the arc of the profiles 9 and 10 of the central portion 8 of the link 1. Each through-opening 12 and 13 has the profile 12c and 13c facing towards the coupling hole 5 or 6 with a concave shape of an arc that parallels the respective coupling hole 5 or 6. The joining lengths 12a, 12b, 12c and 13a, 13b, 13c of the through-openings 12 and 13 are rounded to avoid sharp angles that could provide weak zones subject to breaking.

The openings 12 and 13 are symmetrical with respect to the center 14 of the link 1. A solid area is left adjacent the center 14 of the link. Such a position ensures that the openings 12 and 13 are made in the regions of the link 1 subject to the minimum stresses. Moreover, their shape, increasing in width from the center of the link towards the ends, allows the maximum removal of material of the openings 12 and 13, while keeping the area of the strong cross-section of the central portion 8 of the link 1 substantially constant. This results in weight reduction in the link without substantially decreasing its strength.

In a different embodiment the profile of the through opening 12, 13 facing towards the coupling hole 5, 6 is convex as shown in FIG. 4. In other embodiments, the shape of the through openings 12, 13 could be elliptical (not shown), or circular (not shown). In further embodiments, the size and positioning of the openings could be different. Moreover, the two openings could have different shapes and/or be asymmetrical.

The outer link 1 has a plurality of bevels 20 shown in FIG. 3, located both on the outer face of the link 1 and on the inner face which, according to U.S. Pat. No. 5,741,196 to Campagnolo and incorporated by reference herein, ease the engagement of the chain 50 during its operation. The Campagnolo patent also shows that the central portion 8 is thinner than the rounded ends 3, 4. The boundary 53 between the thinner central portion 8 and thicker ends 3, 4 is preferably rounded to minimize stress (See FIGS. 3, 7, and 9).

FIG. 2 shows an inner link 30 having through-openings 42 and 43 according to the invention and as described for the outer link 1. The inner link 30 differs from the outer link 1 in that it has collars 31 and 32, coaxial with the coupling holes 35 and 36 and in that it has bevels 40 preferably only on its inner face 45 (see FIG. 3). Further, it does not have the difference in thickness between its central portion 8 and circular outer ends. Finally, the edge between the through hole and the central portion and rounded ends is preferably rounded to minimize stress.

FIG. 3 shows a length of chain 50 in which a pair 51 of outer links 1 and 1′ and a pair 52 of inner links 30 and 30′ can be seen in the assembly configuration. In particular, it is possible to see the pin 7, necessary for the assembly of the chain, and the rollers 57 kept in axis with the pins 7 by the inner links′ collars 31 and 32. The rollers are positioned between links 30 and 30′.

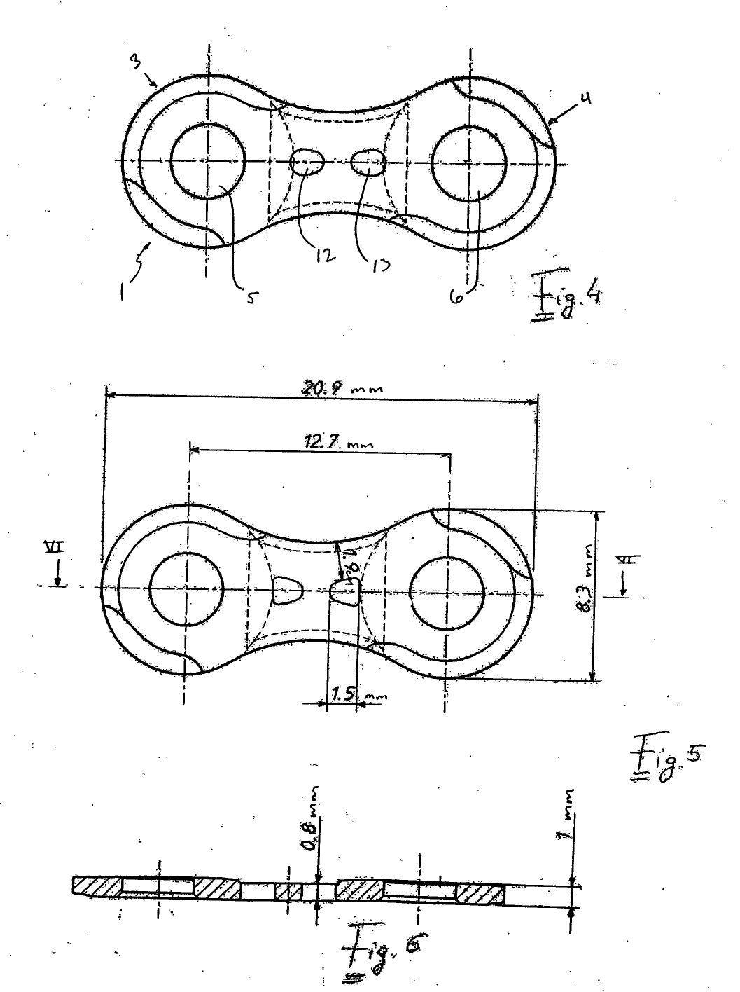

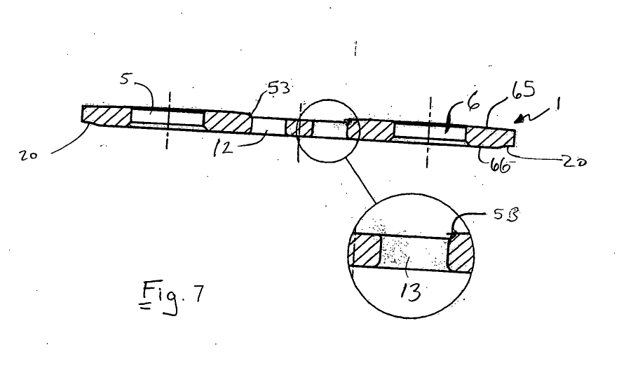

By way of non-limiting example, FIGS. 5 and 6 show examples of the dimensions of an outer link. A 1 mm thick link is about 20.9 mm long and has two coupling holes 5, 6 that have centers separated by 12.7 mm. The openings are approximately 1.5 mm long and separated from the nearest tangent of arc 9 by 1.9 mm. The rounded ends each have a diameter of 8.3 mm. The thickness of the central portion of the link is 0.8 mm.

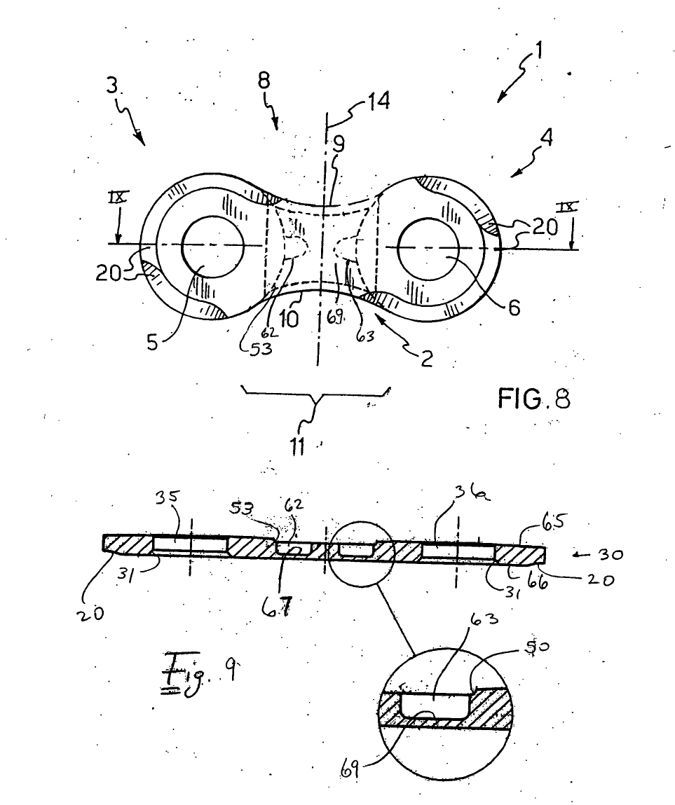

FIGS. 8-9 show an alternate embodiment of the outer link 30. The link has two areas of reduced thickness 62, 63 on the link's inner face 65, although they could also be positioned on the link's outer face 66. The areas of reduced thickness 62, 63 are “cutouts” that do not extend through the link (in contrast to the through-openings), but instead terminate at the floor 67, 69 of each area of reduced thickness.

1. A bicycle transmission chain link having first and second ends and a central portion, the link comprising:
a first coupling hole for receiving a pin, formed at the first end of the chain link;
a second coupling hole, for receiving a pin, formed at the second end of the chain link opposite the first end; and
wherein the central portion is located between the first coupling hole and the second coupling hole and has at least one area of reduced thickness with respect to the remaining part of the central portion.

2. The chain link of claim 1 wherein the area of reduced thickness is located in a region of minimum stress of the link when the link is part of a transmission chain that operates to transmit power from a bicycle rider to a bicycle.

3. The chain link of claim 1 wherein the area of reduced thickness is located in a region between a center of the link and one of the coupling holes.

4. The chain link of claim 3 wherein the size of the area of reduced thickness increases from the center of the link towards the coupling hole.

5. The chain link of claim 1 wherein a profile of the area of reduced thickness is substantially parallel to an outer profile of the link.

6. The chain link of claim 1 wherein a portion of a profile of the area of reduced thickness is concave towards the coupling hole.

7. The chain link of claim 1 wherein a portion of a profile of the area of reduced thickness is convex towards the coupling hole.

8. The chain link of claim 1 wherein the area of reduced thickness has rounded corners.

9. The chain link of claim 3 further comprising a second area of reduced thickness located between the center of the link and the other of the coupling holes.

10. The chain link of claim 9 wherein the first and second areas of reduced thickness are spaced equidistant from the center of the link.

11. The chain link of claim 1 wherein an outer edge of the chain link is beveled.

12. A bicycle chain comprising a series of pairs of outer links and a series of pairs of inner links connected together by a plurality of pins, the links comprising:
a first coupling hole formed at a first end of each chain link; and
a second coupling hole formed at a second end of each chain link opposite the first end;
wherein the coupling holes receive said pins; and
wherein at least one of said links of the chain has at least one area of reduced thickness located between the first coupling hole and the second coupling hole.

13. A method for forming a bicycle chain link comprising the steps of:
forming a bicycle chain link with a first coupling hole formed at a first end of the chain link and a second coupling hole formed at a second end of the chain link opposite the first end; and
removing material from the link to define in the link at least one area of reduced thickness located between the first coupling hole and the second coupling hole.

14. The method of claim 13 wherein the removing step is done using punching.

15. The method of claim 13 wherein the removing step is done using chip machining.

16. A transmission chain link comprising:
first and second ends which are spaced apart by a central portion having a given thickness;
the first end of the link has a first coupling hole for receiving a pin;
the second end of the link has a second coupling hole for receiving a pin; and,
the central portion has at least one area of reduced thickness that is less than the given thickness.

17. A transmission chain link comprising:
first and second ends which are spaced apart by a central portion;
the first end of the link has a predetermined thickness and a first coupling hole for receiving a pin;
the second end of the link has the predetermined thickness and a second coupling hole for receiving a pin; and,
the central portion has a thickness that is less than the predetermined thickness of said ends and has at least two areas of even less thickness between the first and second ends.

18. A transmission chain link comprising:
first and second ends defining a first center line, which are spaced apart by a central portion having a given thickness;
the first end of the link has a predetermined thickness and a first coupling hole on the first center line for receiving a pin;
the second end of the link has the predetermined thickness and a second coupling hole on the first center line for receiving a pin; and,
the central portion has a thickness that is less than the predetermined thickness of said ends, a second center line that is perpendicular to the first center line and at least two areas of reduced thickness located about the second center line and between the first and second ends.

19. The transmission chain link of claim 18 wherein the areas of reduced thickness are defined opposite to each other.

20. The transmission chain link of claim 18 wherein the areas of reduced thickness are shaped as mirror images of each other.

21. A bicycle transmission chain link having first and second ends and a central portion, the link comprising:
a first coupling hole for receiving a pin, formed at the first end of the chain link;
a second coupling hole, for receiving a pin, formed at the second end of the chain link opposite the first end; and
the central portion having at least one through-hole located between the first coupling hole and the second coupling hole.

22. The chain link of claim 21 wherein the through-hole is located in a region of minimum stress of the link when the link is part of a transmission chain that operates to transmit power from a bicycle rider to a bicycle.

23. The chain link of claim 21 wherein the through-hole is located in a region between a center of the link and one of the coupling holes.

24. The chain link of claim 23 wherein the size of the through-hole increases from the center of the link towards the coupling hole.

25. The chain link of claim 21 wherein a profile of the through-hole is parallel to an outer profile of the link.

26. The chain link of claim 21 wherein a portion of a profile of the through-hole is concave towards the coupling hole.

27. The chain link of claim 21 wherein a portion of a profile of the through-hole is convex towards the coupling hole.

28. The chain link of claim 21 wherein the through-hole has rounded corners.

29. The chain link of claim 23 further comprising a second through-hole located between the center of the link and the other of the coupling holes.

30. The chain link of claim 29 wherein the first and second through-holes are spaced equidistant from the center of the link.

31. The chain link of claim 21 wherein an outer edge of the chain link is beveled.

32. A bicycle chain comprising a series of pairs of outer links and a series of pairs of inner links connected together by a plurality of pins, the links comprising:
a first coupling hole formed at a first end of each chain link; and
a second coupling hole formed at a second end of each chain link opposite the first end;
wherein the coupling holes receive said pins; and
wherein at least one of said links of the chain has at least one through-hole located between the first coupling hole and the second coupling hole.

33. A method for forming a bicycle chain link comprising the steps of:
forming a bicycle chain link with a first coupling hole formed at a first end of the chain link and a second coupling hole formed at a second end of the chain link opposite the first end; and
removing material from the link to define in the link at least one through-hole located between the first coupling hole and the second coupling hole.

34. The method of claim 33 wherein the removing step is done using punching.

35. The method of claim 33 wherein the removing step is done using chip machining.

36. The method of claim 33 wherein the removing step is done using laser cutting.

37. A transmission chain link comprising:
first and second ends which are spaced apart by a central portion having a given thickness;
the first end of the link has a first coupling hole for receiving a pin;
the second end of the link has a second coupling hole for receiving a pin; and,
the central portion has at least one through-hole.

38. A transmission chain link comprising:
first and second ends which are spaced apart by a central portion;
the first end of the link has a predetermined thickness and a first coupling hole for receiving a pin;
the second end of the link has the predetermined thickness and a second coupling hole for receiving a pin; and,
the central portion has a thickness that is less than the predetermined thickness of said ends and has at least two through-holes between the first and second ends.

39. A transmission chain link comprising:
first and second ends defining a first center line, which are spaced apart by a central portion having a given thickness;
the first end of the link has a predetermined thickness and a first coupling hole on the first center line for receiving a pin;
the second end of the link has the predetermined thickness and a second coupling hole on the first center line for receiving a pin; and,
the central portion has a thickness that is less than the predetermined thickness of said ends, a second center line that is perpendicular to the first center line and at least two through-holes located about the second center line and between the first and second ends.

40. The transmission chain link of claim 39 wherein the through-holes are defined opposite to each other.

41. The transmission chain link of claim 39 wherein the through-holes are shaped as mirror images of each other.

42. A method for forming a bicycle chain link comprising the steps of:
providing a solid bicycle chain link;
removing material from said solid link to form a first coupling hole formed at a first end of the chain link and a second coupling hole formed at a second end of the chain link opposite the first end; and
removing material from a central portion of the solid bicycle chain link to form at least an area of reduced thickness therein.

43. The method of claim 42 wherein the removing step is done using punching.

44. The method of claim 42 wherein the removing step is done using chip machining.

45. A method for forming a bicycle chain link comprising the steps of:
providing a solid bicycle chain link;
removing material from said solid link to form a first coupling hole formed at a first end of the chain link and a second coupling hole formed at a second end of the chain link opposite the first end; and
removing material from a central portion of the solid bicycle chain link to form at least one through-hole therein.

46. The method of claim 45 wherein the removing step is done using punching.

47. The method of claim 45 wherein the removing step is done using chip machining.

48. The method of claim 45 wherein the removing step is done using laser cutting.
